(19) United States
(12) Patent Application Publication
(10) Pub. No.: US 2021/0289277 A1
(43) Pub. Date: Sep. 16, 2021

(54) Character Comfort Headphones

(71) Applicant: Paul D Miller, Wilmington, NC (US)

(72) Inventor: Paul D Miller, Wilmington, NC (US)

(21) Appl. No.: 16/484,377

(22) PCT Filed: Oct. 31, 2017
(86) PCT No.: PCT/US17/59409

§ 371 Date: Aug. 7, 2019

Related U.S. Application Data
(60) Provisional application No. 62/415,386, filed on Oct. 31, 2016.

(51) Int. Cl. H04R 1/10; A41D 20/00; H04R 1/02

(52) U.S. Cl. CPC H04R 1/105; H04R 2201/023; H04R 1/028; A41D 20/00

(57) ABSTRACT

Embodiments of the Character Comfort Headphones are comprised of a fabric strip in the shape of a playful animal, or character, a hook and loop fastener with the hook fastener on one end of the fabric strip and the loop fastener at another end of the fabric strip. The fabric strip forms an inter channel within the fabric strip for placement of headphones. The fabric strip forms openings on either end of the fabric strip to accept the headphones and speaker wire that powers the headphones. The headphone locations can be adjusted as needed to place the headphones over the user's ears.

### CROSS-REFERENCE TO RELATED APPLICATIONS

This application is a continuation patent application of, and claims priority from, U.S. Provisional Patent Application Ser. No. 62/415,386 filed on Oct. 31, 2016, which is incorporated by reference herein in its entirety for all purposes.

### BACKGROUND OF THE EMBODIMENTS

### Field of the Embodiments

The general field of the embodiments of the Character Comfort Headphones is wearable headphones. More specifically the field of the embodiments relates to headphones that provide a comfortable and fun experience while wearing the headphones.

### Description of Prior Art

The prior art includes headphones currently on the market that provide coverings for the ears for the user.

### SUMMARY OF THE EMBODIMENTS

Embodiments ante Character Comfort Headphones are comprised of a fabric strip in the shape of a playful animal or character, a hook and loop fastener with the hook fastener on one end of the fabric strip and the loop fastener at another end of the fabric strip. The fabric strip forms an inter channel within the fabric strip for placement of headphones. The fabric strip forms openings on either end of the fabric strip to accept the headphones and speaker wire that powers the headphones. The headphone locations can be adjusted as needed to place the headphones over the user's ears.

There has thus been outlined rather broadly, the more important features of the embodiments in order that the detailed description thereof that follows may be better understood, and in order that the present contribution to the art may be better appreciated. There are, of course, additional features of the embodiments that will be described hereinafter and which will form the subject matter of the claims appended hereto.

In this respect, before explaining at least one embodiment of the embodiments in detail, it Is to be understood that the embodiment is not limited in this application to the details of construction and to the arrangements of the components set forth in the following description or illustrated in the drawings. The embodiment or embodiments are capable of other embodiments and of being practiced and carried out in various ways. Also, it is to be understood that the phraseology and terminology employed herein are for the purpose of description and should not be regarded as limiting. As such those skilled in the art will appreciate that the conception, upon which this disclosure is based, may readily be us used as a basis for the designing of other structures, methods and systems for carrying out the several purposes of the embodiments. Additional benefits and advantages of the embodiments will become apparent in those skilled in the art to which the present embodiments relate from the subsequent description of the preferred embodiment and the appended claims, taken in conjunction with the accompanying drawings. It is important, therefore, that the claims be regarded as including such equivalent constructions insofar as they do not depart from the spirit and scope of the embodiments.

Further, the purpose f the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application which is measured by the claims, nor is it intended to be limiting as to the scope of the embodiments in any way.

### BRIEF DESCRIPTION OF THE DRAWINGS

FIG. 1A is a perspective view of an embodiment of the Character Comfort Headphones.

FIG. 1A is a perspective view of an embodiment of the Character Comfort Headphones; FIG. 1B is a perspective view of a back view of the Character Comfort Headphones.

FIG. 2A is a front view of an embodiment of the Character Comfort Headphones in that with the headphones expanded; FIG. 2B is a back view of an embodiment of the Character Comfort Headphones with the headphones expanded; FIG. 2C is an embodiment of the Character Comfort Headphones showing placement of the headphones in the in the headband

FIG. 3A is a front view of an embodiment of the Character Comfort Headphones showing a front view; FIG. 3B is a back view of an embodiment of the Character Comfort Headphones showing a back view.

FIG. 4 is an embodiment of the Character Comfort Headphones in a perspective view showing the frog pattern.

FIG. 5A is an embodiment the Character Comfort Headphones and a perspective view showing the frog patterns; FIG. 5B is an embodiment of the Character Comfort Headphones showing a rear perspective view showing the placement of the headphones.

FIG. 6 is a schematic of an embodiment of the Character Comfort Headphones showing the arrangement of the felt to the headphone.

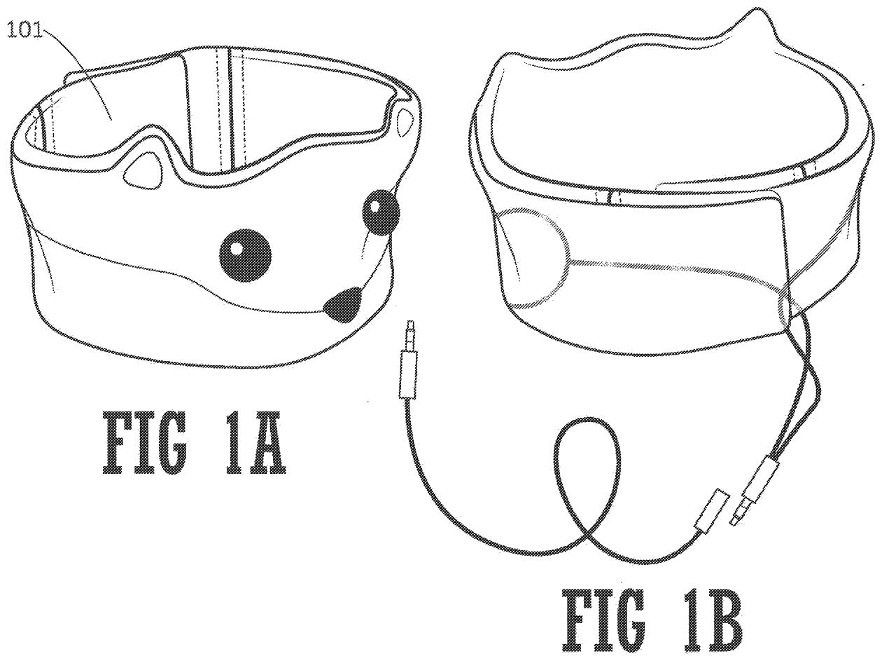

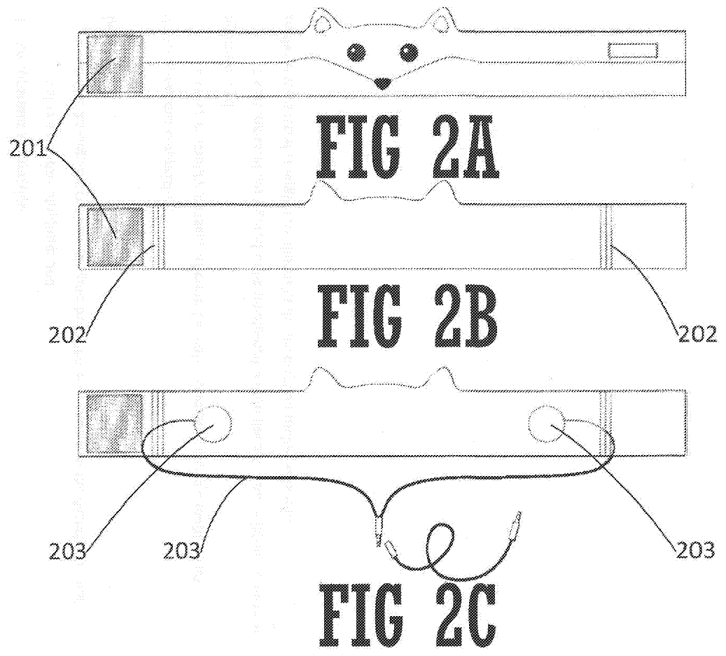

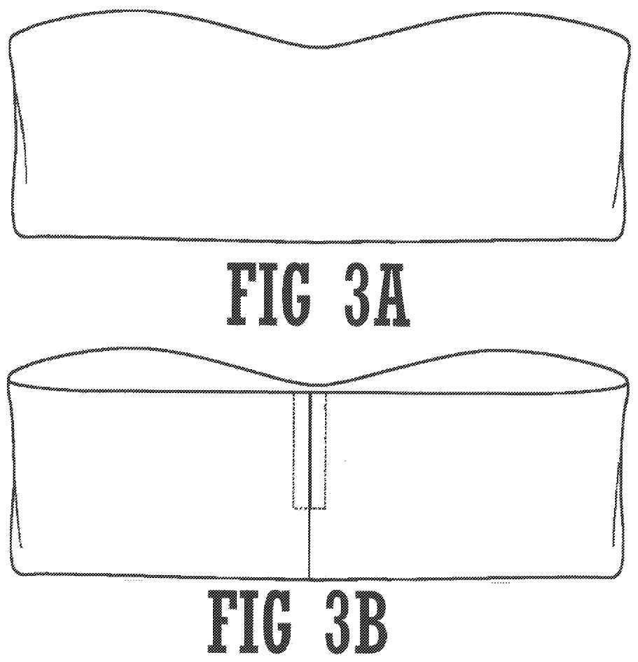

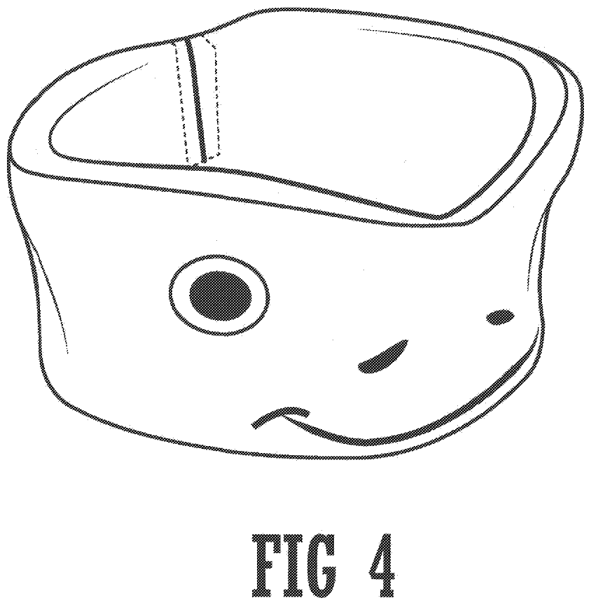

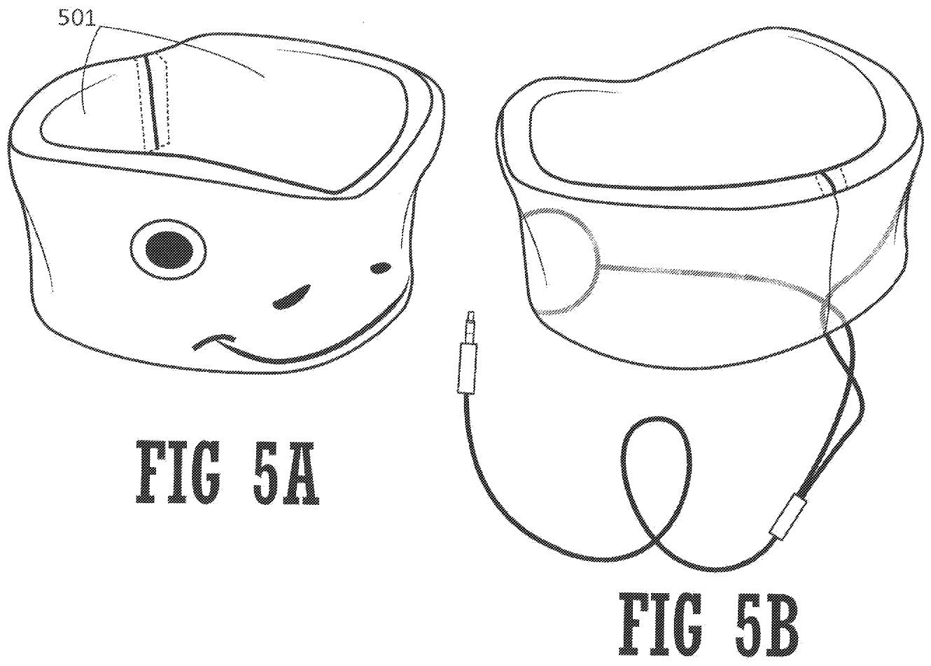

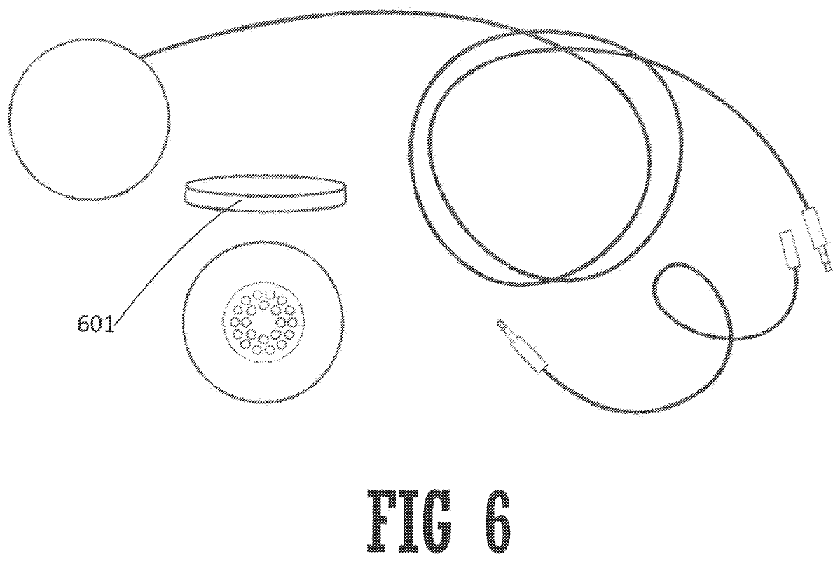

### DETAILED DESCRIPTION OF THE PREFERRED EMBODIMENTS

Embodiments of the Character Comfort Headphones are comprised of a fabric strip 101 in the shape of a playful animal or character, a hook and loop fastener 201 with the hook fastener on one end of the fabric strip and the loop fastener at another end of the fabric strip. The fabric strip forms an inter channel within the fabric strip for placement of headphones. The fabric strip forms openings 202 on either end of the fabric strip to accept the headphones 203 and speaker wire 204 that powers the headphones. The headphone locations can be adjusted as needed to place the headphones over the user's ears. The Character Comfort Headphones are applied to the user's head and the headphones are adjusted. To secure the headphones, the hook and loop fasteners 201 on the ends of the fabric strip are connected and secured to each other. The hook and loop fasteners 201 can be adjusted to suit the tightness of the fabric strip on the user. Felt material 601 in the shape of an “O” is attached to the speakers. This felt material 601 allows for added comfort for the user. In addition, this felt material 601 serves to loosely secure the speakers to the inside of the fabric strip and to prevent the speakers from moving during use. In one embodiment of the comfort headphones, the volume of the speakers is limited to no more than 85 dB.

In another embodiment of the Character Comfort Headphones the fabric strip is continuous. That is, the fabric strip is stitched together to form a continuous loop 501. In this embodiment, the Character Comfort Headphones are slipped onto the head of the user without the use of hook and loop fasteners to secure the fabric strip.

An embodiment may include Bluetooth communications between the speakers and a wireless source. An embodiment may include adjustable snaps or elastic to adjust the size of the headband. Another or the embodiment may include in-line volume control. Other embodiments may include an integrated sleep mask (e.g., covering a wearer's eyes), adjustable eyecups, or a cooling pack.

An embodiment may include circuitry to sense sleep sounds (e.g., snoring or breathing) and produce relaxing sounds to help a user sleep. An embodiment may include a fastener (e.g., a snap, metal, plastic, velcro, buttons.) The fastener may allow for the interchangeability of accessories (e.g., different characters) for headband headphones, generally. An embodiment may include GPS tracking to locate the wearer. Another embodiment may include cameras, A non-slip silicone on outside speakers may be positioned to hold speakers in place and insulate against sound leakage to outside (e.g., by molding to the ear to block out sound). In one embodiment, a speaker may be adjacent, embedded, or recessed within silicone gel or memory foam. Felt or another layer of gel or foam may be on the opposite side. An embodiment includes a controller in communication with the speakers and a memory storing program code and stored audio material. Silk screens may be used to create different visual effects. An embodiment may include a zipper and pocket to house the speakers. The zipper may be installed on both sides under each side of ear position.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and features as defined by the following claims

What is claimed is:

1) A character comfort headphone comprising
a) a fabric strip in the shape of a playful animal or character;
i) wherein the fabric strip forms an inter channel within the fabric strip for placement of headphones;
ii) wherein the fabric strip forms openings on either end of the fabric strip to accept the headphones and speaker wire that powers the headphones; and
b) a fastener with one component on one end of the fabric strip and another component of the fastener at another end of the fabric strip.

2) The comfortable headphone described in claim 1 where the fastener is hook and loop fastener.
